(19) United States
(12) Patent Application Publication
(10) Pub. No.: US 2025/0338381 A1
(43) Pub. Date: Oct. 30, 2025

(54) VEHICLE INTERIOR LIGHTING SYSTEM

(71) Applicant: TOYODA GOSEI CO., LTD., Kiyosu-shi (JP)

(72) Inventors: Yoshikazu ONISHI, Kiyosu-shi (JP); Tetsuro NISHIYAMA, Kiyosu-shi (JP)

(21) Appl. No.: 19/178,129

(22) Filed: Apr. 14, 2025

(30) Foreign Application Priority Data
Apr. 26, 2024 (JP) 2024-072563
Oct. 23, 2024 (JP) 2024-186668

(51) Int. Cl. H05B 47/18; B60Q 1/00; B60Q 3/80

(52) U.S. Cl. CPC H05B 47/18; B60Q 1/0088; B60Q 3/80

(57) ABSTRACT

A vehicle interior lighting system that performs LIN communication or CAN communication, the vehicle interior lighting system including plural lamp units connected by one or two bus cables, and a host ECU that transmits an effect production instruction signal to the plural lamp units through the bus cable or cables, the effect production instruction signal instructing a content of an effect produced by a light emission operation of the plural lamp units. Each of the plural lamp units includes a light-emitting element and a control IC that controls output of the light-emitting element according to the content of the effect production instruction signal. The effect production instruction signal is transmitted once to each of the plural lamp units per effect production instruction, regardless of duration of effect.

### Cross-Reference to Related Applications

The present patent application claims the priority of Japanese patent application Nos. 2024/072563 and 2024/186668 filed on Apr. 26, 2024 and Oct. 23, 2024, respectively, and the entire contents of Japanese patent application Nos. 2024/072563 and 2024/186668 are hereby incorporated by reference.

### TECHNICAL FIELD

The present invention relates to a vehicle interior lighting system.

### BACKGROUND ART

A lighting unit used in a vehicle is known which includes plural lighting loads, a control unit that outputs a control signal to control the lighting loads independently, and a wire harness structure that connects the plural lighting loads to the control unit (see PTL 1).

In the lighting unit described in PTL 1, a built-in chip in a relay connector of the wire harness structure controls the power supply to each lighting load in accordance with the control signal transmitted from the control unit, allowing the load on the control unit to be reduced.

### CITATION LIST

### Patent Literature

PTL 1: JP 2012/133985 A

### SUMMARY OF INVENTION

In the lighting unit described in PTL 1, however, one signal line is used for each lighting load for connection of the plural lighting loads to the relay connector of the wire harness structure. Therefore, this lighting unit is heavy and large in size and thus takes up space when arranged.

It is an object of the invention to provide a vehicle interior lighting system in which the number of wires connecting plural lamp units to a host ECU that controls the plural lamp units is small and which can also suppress an amount of data in an instruction signal transmitted from the host ECU to the plural lamp units.

An aspect of the invention provides a vehicle interior lighting system as defined below.

(1) A vehicle interior lighting system that performs LIN communication or CAN communication, the vehicle interior lighting system comprising:
a plurality of lamp units connected by one or two bus cables; and
a host ECU that transmits an effect production instruction signal to the plurality of lamp units through the bus cable or cables, the effect production instruction signal instructing a content of an effect produced by a light emission operation of the plurality of lamp units,
wherein each of the plurality of lamp units comprises a light-emitting element and a control IC that controls output of the light-emitting element according to the content of the effect production instruction signal, and
wherein the effect production instruction signal is transmitted once to each of the plurality of lamp units per effect production instruction, regardless of duration of effect.

(2) The vehicle interior lighting system defined in (1), wherein each time transmitting the effect production instruction signal, the host ECU combines only necessary pieces among a plurality of pieces of instruction information and includes the combination in the effect production instruction signal.

(3) The vehicle interior lighting system defined in (1) or (2), wherein when instruction information that specifies an operation of simultaneously changing outputs of the plurality of lamp units is included in the effect production instruction signal, timings at which the control ICs of the plurality of lamp units change outputs of the light-emitting elements are synchronized.

(4) The vehicle interior lighting system defined in (1) or (2), wherein each of the plurality of lamp units comprises a plurality of the light-emitting elements.

(5) The vehicle interior lighting system defined in (1) or (2), wherein the vehicle interior lighting system performs LIN communication, and wherein the number of nodes of the plurality of lamp units is not less than 15.

### ADVANTAGEOUS EFFECTS OF INVENTION

According to the invention, it is possible to provide a vehicle interior lighting system in which the number of wires connecting plural lamp units to a host ECU that controls the plural lamp units is small and which can also suppress an amount of data in an instruction signal transmitted from the host ECU to the plural lamp units.

### BRIEF DESCRIPTION OF DRAWINGS

FIG. 1 is a schematic block diagram illustrating a configuration of a vehicle interior lighting system in an embodiment of the present invention.

FIG. 2A is a conceptual diagram illustrating timing of signal transmission from a host ECU to a lamp unit during producing an effect in a known lighting system that performs LIN communication.

FIG. 2B is a conceptual diagram illustrating timing of signal transmission from a host ECU to a lamp unit during producing an effect in the vehicle interior lighting system in the embodiment of the invention.

FIG. 3 is a schematic diagram illustrating an example of effect production instruction information included in an effect production instruction signal S₁.

FIG. 4A is a side view showing a light guide to which not less than two of the lamp units connected by one bus cable are to be connected.

FIG. 4B is an external view when the lamp units supplying light to the light guide and a housing to house the light guide are attached to the light guide.

FIGS. 5A to 5C are schematic diagrams for comparison of the number of wires between the known lighting unit as Comparative Example and the vehicle interior lighting systems in the embodiment of the invention.

### DESCRIPTION OF EMBODIMENTS

### Configuration of a Vehicle Interior Lighting System

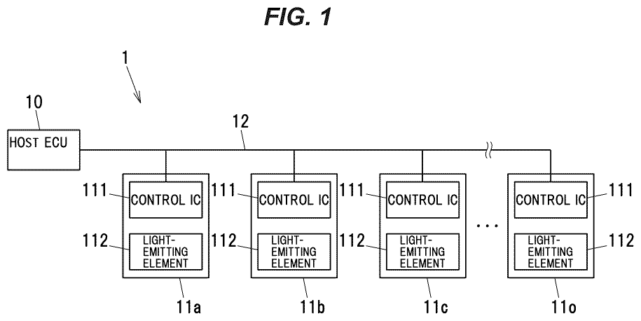

FIG. 1 is a schematic block diagram illustrating a configuration of a vehicle interior lighting system 1 in an embodiment of the invention. In FIG. 1, power supply and GND are omitted.

The vehicle interior lighting system 1 includes plural lamp units 11 that are connected by one bus cable 12, and a host ECU (Electronic Control Unit) 10 that transmits an effect production instruction signal to the plural lamp units 11 through the bus cable 12.

The vehicle interior lighting system 1 is a vehicle interior lighting system which performs LIN (Local Interconnect Network) communication and in which the plural lamp units 11 connected by one bus cable 12 can be controlled by one host ECU 10.

In the example shown in FIG. 1, the number of nodes of the lamp units 11 (the number of lamp units connected by one bus cable) is 15, and fifteen lamp units 11 (11a to 11o) are included in the vehicle interior lighting system 1. In this regard, LIN communication standard recommends that the maximum number of slave devices connected to one master device be 15 due to its communication capacity.

Each lamp unit 11 includes a light-emitting element 112, such as an LED, as a light source, and a control IC 111, such as a microcomputer (microcontroller), that controls output of the light-emitting element 112 according to the content of the received effect production instruction signal.

Each lamp unit 11 may include plural light-emitting elements 112. Typically, each lamp unit 11 includes a light-emitting element 112 that emits red light, a light-emitting element 112 that emits green light, and a light-emitting element 112 that emits blue light.

The effect production instruction signal is a signal to instruct the content of an illumination effect produced by light emitted from the plural lamp units 11 included in the vehicle interior lighting system 1 (hereinafter, sometimes simply referred to as an effect). Examples of the effect include effects in which the plural lamp units 11 fade in or out at one time, turn on or off sequentially from one end, and repeat turning on and off randomly for a predetermined period of time, etc.

The effect production instruction signal includes effect production instruction information to instruct the plural lamp units 11 to produce an effect. The effect production instruction information is composed of, e.g., a combination of plural pieces of instruction information, such as position information, brightness information, color information, and operation information.

The position information is information specifying that operation of which unit/units among the plural lamp units 11 is to be controlled, and the control IC 111 of the specified lamp unit 11 operates the light-emitting element 112.

The brightness information is information that specifies light emission intensity of the lamp unit 11, and the control IC 111 of the lamp unit 11 changes output of the light-emitting element 112 based on the brightness information.

The color information is information that specifies emission color of the lamp unit 11, and the control IC 111 of the lamp unit 11 changes the output of each of the plural light-emitting elements 112 that emit different colors, based on the color information.

The operation information is information that specifies overall movement of the plural lamp units 11, e.g., whether the brightness of the plural lamp units 11 is changed simultaneously, sequentially, or randomly, and based on the operation information, the control IC 111 of each lamp unit 11 controls timing of operation of the light-emitting element 112.

In each lamp unit 11, the control IC 111 derives a time schedule for power supply to the light-emitting element 112 to realize the instructed effect, based on the effect production instruction information included in the effect production instruction signal transmitted from the host ECU 10. Then, the amount of power supplied to the light-emitting element 112 is changed in accordance with the derived time schedule to control the output of the light-emitting element 112.

The host ECU 10 may be connected to a vehicle control device that is composed of an ECU, etc. and is capable of notifying the host ECU 10 of the state of the vehicle. In this case, when, e.g., the vehicle control device notifies the host ECU 10 that, e.g., a drive unit of the vehicle has been started or the vehicle has been unlocked, the host ECU 10 transmits an effect production instruction signal to the plural lamp units 11 according to the content of the notification.

The host ECU 10 may also be connected to an operation unit that is to instruct the plural lamp units 11 to produce an effect and is operated by a vehicle occupant. In this case, when the host ECU 10 is notified that, e.g., the operation unit has been operated by an occupant, the host ECU 10 transmits an effect production instruction signal to the plural lamp units 11 according to the content of the instructed effect.

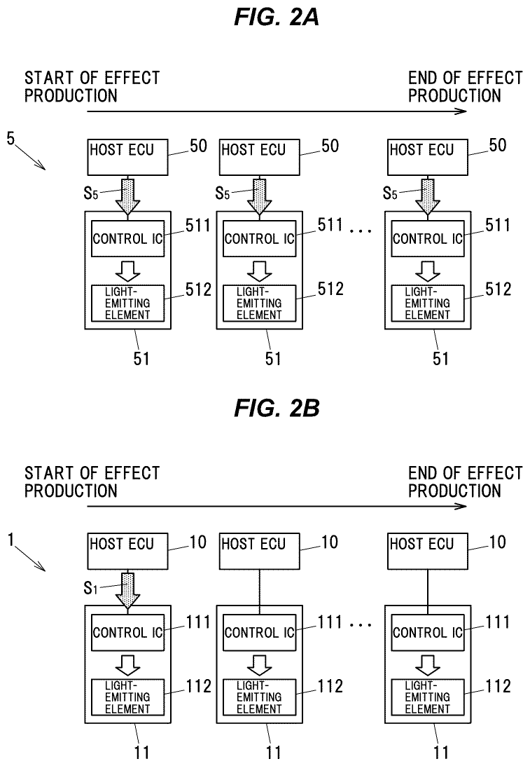

FIG. 2A is a conceptual diagram illustrating timing of signal transmission from a host ECU 50 to a lamp unit 51 during producing an effect in a known lighting system 5 that performs LIN communication. FIG. 2B is a conceptual diagram illustrating timing of signal transmission from the host ECU 10 to the lamp unit 11 during producing an effect in the vehicle interior lighting system 1 in the embodiment of the invention.

Each arrow between a control IC 511 and a light-emitting element 512 in FIG. 2A indicates that the output of the light-emitting element 512 is controlled by the control IC 511. Likewise, each arrow between the control IC 111 and the light-emitting element 112 in FIG. 2B indicates that the output of the light-emitting element 112 is controlled by the control IC 111.

In the known lighting system 5, the host ECU 50 transmits a signal S₅, which includes output information specifying the output of the light-emitting element 512 (when the lamp unit 51 includes plural light-emitting elements 512, output information for each of the plural-light emitting elements 512), to the lamp unit 51. The control IC 511 of the lamp unit 51 that received the signal S₅ controls the output of the light-emitting element 512 according to the output information for the light-emitting element 512 included in the signal S₅.

Then, when the plural lamp units 51 are operated to emit light to produce an effect, the host ECU 50 repeatedly sends the signal S₅ to the plural lamp units 51 until the end of the effect. Therefore, the longer the duration of the effect, the greater the number of times of transmitting the signal S₅, and the greater the communication volume required to produce that effect.

For example, when producing an effect in which all the lamp units 51 fade in over a period of X seconds, the host ECU 50 repeatedly transmits the signal S₅, which specifies the output to be gradually increased, to all the lamp units 51 for X seconds.

On the other hand, in the vehicle interior lighting system 1 in the embodiment of the invention, the host ECU 10 sends the effect production instruction signal Si to the lamp unit 11, and the control IC 111 of the lamp unit 11 controls the output of the light-emitting element 112 according to the information about the content of the effect included in the effect production instruction signal S₁.

In the vehicle interior lighting system 1, the effect production instruction signal S₁ does not instruct the output of the light-emitting element 112 as does the above-described signal S₅, but rather instructs the content of the effect. Therefore, the effect production instruction signal S₁ is transmitted only once to each of the plural lamp units 11 per effect production instruction regardless of the duration of that effect, and the specific operation of the light-emitting element 112 is controlled by the control IC 111 that received the effect production instruction signal S₁.

In addition, since the effect production instruction signal S₁ is transmitted only once to each of the plural lamp units 11 per effect production instruction, the communication volume of the effect production instruction signal S₁ transmitted to produce one effect is constant regardless of the duration of the effect.

In the case of producing, e.g., an effect in which all the lamp units 11 fade in over a period of X seconds, the host ECU 10 transmits the effect production instruction signal S₁ once to each of the lamp units 11, where the effect production instruction signal S₁ includes, as the effect production instruction information, e.g., the position information specifying all the lamp units 11 as objects to be controlled and the brightness information instructing to increase the brightness up to brightness Y over a period of X seconds. The control ICs 111 of all the lamp units 11 that received the effect production instruction signal S₁ derive a time schedule for power supply to the light-emitting elements 112 to increase the brightness of the lamp units 11 to the brightness Y in X seconds, and control the outputs of the light-emitting elements 112 for X seconds.

Next, estimation results of the communication volume, etc., in the known lighting system 5 and the vehicle interior lighting system 1 when making fifteen lamp units fade in over a period of three seconds will be described as an example. In this specific example, it is assumed that the traffic volume per communication is 8 bytes and that each communication takes 10 ms.

In the known lighting system 5, when assuming that the signal S₅ can be transmitted to two lamp units 51 per communication, the signal S₅ can be transmitted to all the fifteen lamp units 51 in eight communications. Therefore, the communication volume and time required to transmit the signal S₅ once to all of the lamp units 51 are respectively 64 bytes (8 bytes×8 communications) and 80 ms (10 ms×8 communications).

Then, when transmission of the signal S₅ once to all of the lamp units 51 is defined as one cycle, the number of cycles in 3 seconds until the end of the fade-in lighting effect is 38 (3000 ms÷80 ms), and the total communication volume in 3 seconds is 2432 bytes (64 bytes×38 cycles).

On the other hand, in the vehicle interior lighting system 1, when assuming that the effect production instruction signal S₁ can be transmitted to one lamp unit 11 per communication, the effect production instruction signal S₁ can be transmitted to all the fifteen lamp units 11 in fifteen communications. Therefore, the communication volume and time required to transmit the effect production instruction signal S₁ once to all of the lamp units 11 are respectively 120 bytes (8 bytes×15 communications) and 150 ms (10 ms×15 communications).

Since the effect production instruction signal S₁ is transmitted only once for one effect, the number of cycles in 3 seconds until the end of the fade-in lighting effect is 1 (the operation of the lamp units 11 to emit light for 3 seconds is controlled by the control ICs 111 which received the effect production instruction signal S₁), and the total communication volume in 3 seconds is 120 bytes (120 bytes×1 cycle).

As described above, in the known lighting system 5, the longer the duration of the effect, the larger the communication volume becomes, and it is therefore necessary to store large amounts of data in the host ECU 50 which is the source of the communication. Therefore, it is not possible to produce an effect for long time or to produce a delicate effect.

In contrast, the vehicle interior lighting system 1 can suppress the communication volume from the host ECU to the lamp units as compared to the known lighting system 5, and thus can produce an effect for longer time or produce a more delicate effect. For example, when producing the fade-in lighting effect which is described above as an example, it is possible to smoothly change the brightness or to increase the brightness over a long period of time.

Therefore, it is possible to produce, e.g., an effect of flowing light by making the plural lamp units 11 sequentially fade in from one end.

In addition, a difference in communication volume between the known lighting system 5 and the vehicle interior lighting system 1 increases with an increase in the number of nodes of lamp units. Therefore, when the number of nodes of the lamp units 11 is 15, which is the maximum number generally recommended for LIN communication, or is larger than 15, the communication volume difference with the known lighting system is particularly large.

In the vehicle interior lighting system 1, the combination of pieces of the effect production instruction information included in the effect production instruction signal S₁ can be changed each time the effect production instruction signal S₁ is transmitted. The effect production instruction information included in the effect production instruction signal S₁ is composed of a combination of plural pieces of the instruction information, such as the position information, the brightness information, the color information, and the operation information as described above, and only the necessary pieces of the instruction information can be combined and included in the effect production instruction signal S₁ each time the effect production instruction signal S₁ is transmitted, which allows the communication volume to be reduced.

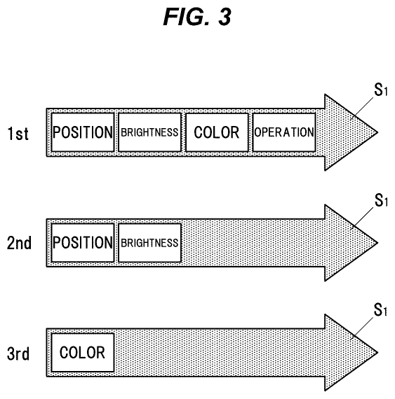

FIG. 3 is a schematic diagram illustrating an example of the effect production instruction information included in the effect production instruction signal S₁. FIG. 3 conceptually shows that the effect production instruction signal S₁ marked “1st” is the first signal to be transmitted, the effect production instruction signal S₁ marked “2nd” is the second signal to be transmitted, and the effect production instruction signal S₁ marked “3rd” is the third signal to be transmitted.

In the example shown in FIG. 3, first, the effect production instruction signal S₁, which includes the position information, the brightness information, the color information, and the operation information as the effect production instruction information, is transmitted from the host ECU 10 to the plural lamp units 11 to instruct to produce the first effect.

Then, when the difference between the content of the first effect and the content of the second effect is only the position of the lamp unit 11 to be operated and the brightness of the lamp unit 11, the effect production instruction signal S₁ including only the position information and the brightness information as the effect production instruction information is transmitted to instruct to produce the second effect. In other words, the color information and the operation information, which specify the same color and operation of the lamp unit 11 as those in the first effect, are not included as the effect production instruction information in the effect production instruction signal S₁.

Then, when the difference between the content of the second effect and the content of the third effect is only the color of the light emitted by the lamp unit 11, the effect production instruction signal S₁ including only the color information as the effect production instruction information is transmitted to instruct to produce the third effect.

The vehicle interior lighting system 1 is superior to the known lighting system 5 performing LIN communication in that the outputs of the plural lamp units 11 can be changed simultaneously.

In LIN communication, the instruction signal is sent from the host ECU to the plural lamp units in sequence. Therefore, in the known lighting system 5 in which the host ECU 50 transmits the signal S₅ including the output information specifying the output of the light-emitting element 512 to the plural lamp units 51, timing of changing the output is slightly off between the plural lamp units 51 when the signal S₅ to change the outputs of the plural lamp units 51 is transmitted.

On the other hand, in the vehicle interior lighting system 1, the timings at which the control ICs 111 of the plural lamp units 11 change the outputs of the light-emitting elements 112 of the plural lamp units 11 can be synchronized by transmitting the effect production instruction signal S₁, which includes the instruction information specifying an operation of simultaneously changing the outputs of the plural lamp units 11 (one of the above-mentioned operation information) as the effect production instruction information, to the plural lamp units 11. This allows the plural lamp units 11 to simultaneously turn on, turn off, or change the brightness, etc.

The vehicle interior lighting system 1 may be configured such that one host ECU 10 controls plural lamp unit groups (groups each composed of plural lamp units 11 connected by one bus cable 12).

In addition, the vehicle interior lighting system 1 may be used as part of another network, such as Controller Area Network (CAN). In this case, for example, a gateway that performs conversions between CAN communication and LIN communication corresponds to the host ECU 10.

### Example Arrangement of the Lamp Units

The lamp unit 11 is used as a light source for, e.g., cowl illumination, foot illumination, door illumination, or luggage room illumination. The lamp units 11 arranged at different positions inside the vehicle may be connected to each other by one bus cable 12. In addition, for example, not less than two of the plural lamp units 11 connected to one bus cable 12 in the vehicle interior lighting system 1 may be connected to the same light guide.

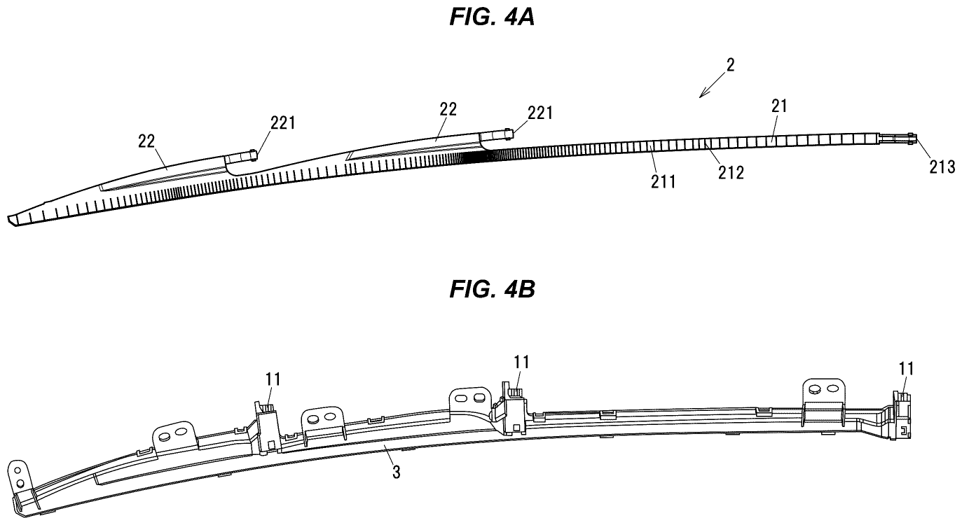

FIG. 4A is an external view showing a light guide 2 to which not less than two of the lamp units 11 connected by one bus cable 12 are to be connected. The light guide 2 includes a rod-shaped first light-guiding portion 21 on which a prism surface 211 with a prism 212 to reflect light propagating inside and emit the light to the outside is provided along a length direction thereof, and rod-shaped second light-guiding portions 22 formed integrally with the rod-shaped first light-guiding portion 21. The first light-guiding portion 21 and the second light-guiding portion 22 respectively have a light intake portion 213 and a light intake portion 221 at an end to take in light from the lamp units 11. The prism 212 is composed of, e.g., a group of linear grooves or protrusions that are lined up on the prism surface 211 and each extend in a direction orthogonal to the length direction of the first light-guiding portion 21.

FIG. 4B is an external view when the lamp units 11 supplying light to the light guide 2 and a housing 3 to house the light guide 2 are attached to the light guide 2. The lamp units 11 provide light to the light intake portion 213 and the light intake portions 221 of the light guide 2. For example, each of the light guide 2 and the lamp units 11 is fixed to the housing 3, and the light guide 2, the lamp units 11 and the housing 3 constitute a lighting device used for vehicle interior, etc., such as an instrument panel.

Light emitted from the lamp unit 11 enters the first light-guiding portion 21 from the light intake portion 213 or the light intake portion 221 of the second light-guiding portion 22, is reflected at the prism 212, and exits to the outside from a surface of the first light-guiding portion 21 opposite to the prism surface 211.

### Modification

The vehicle interior lighting system 1 has been described as a system that performs LIN communication in the above embodiment, but the vehicle interior lighting system 1 may be a system that performs CAN communication. That is, also when the vehicle interior lighting system 1 is a system that performs CAN communication, the above-described configuration makes it possible to control the operation of the plural lamp units 11 by the effect production instruction signal that is transmitted only once from the host ECU 10 to each of the plural lamp units 11 to produce one effect.

The system performing CAN communication differs from the system performing LIN communication in the communication speed (1000 kbps for CAN communication and 19.2 kbps for LIN communication) and in that two bus cables 12 are used for communication between the host ECU 10 and the plural lamp units 11.

Also when the vehicle interior lighting system 1 is a system that performs CAN communication, it is possible to suppress the number of wires connecting the plural lamp units to the host ECU that controls the plural lamp units, and also suppress the amount of data in the instruction signal transmitted from the host ECU to the plural lamp units, as compared to known lighting units in which each of light sources included in lamp units is connected to a host ECU by an independent signal line, as is in the lighting unit described in PTL 1.

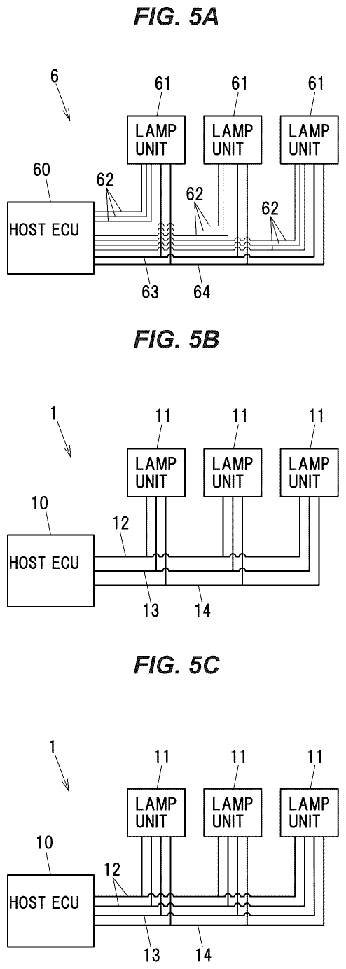

FIGS. 5A to 5C are schematic diagrams for comparison of the number of wires between the known lighting unit 6 as Comparative Example and the vehicle interior lighting systems 1 in the embodiment of the invention. In FIGS. 5A to 5C, the number of nodes of lamp units is 3, as an example.

In the lighting unit 6 shown in FIG. 5A, each of lamp units 61 has an R light source emitting red light, a G light source emitting green light and a B light source emitting blue light, and each of the three light sources is connected to a host ECU 60 by a signal line 62 to transmit a control signal to adjust the brightness of the light source. In addition, the three lamp units 61 are commonly connected to one power line 63 and one GND line 64.

In the lighting unit 6, one signal line 62 is used for each of the three light sources included in the lamp unit 61. Therefore, when the number of nodes of the lamp units 61 included in the lighting unit 6 is n, the total number of wires connecting the host ECU 60 to the n lamp units 61 is 3n+2 (3n signal lines 62, one power line 63, and one GND line 64).

FIG. 5B shows the vehicle interior lighting system 1 that performs LIN communication. In the vehicle interior lighting system 1 that performs LIN communication, the plural lamp units 11 are connected by one bus cable 12, as described above. Therefore, in the vehicle interior lighting system 1 that performs LIN communication, the total number of wires connecting the host ECU 10 to the plural lamp units 11 is three (one bus cable 12, one power line 13, and one GND line 14), regardless of the number of nodes of the lamp units 11.

FIG. 5C shows the vehicle interior lighting system 1 that performs CAN communication. In the vehicle interior lighting system 1 that performs CAN communication, the plural lamp units 11 are connected by two bus cables 12. Therefore, in the vehicle interior lighting system 1 that performs CAN communication, the total number of wires connecting the host ECU 10 to the plural lamp units 11 is four (two bus cables 12, one power line 13, and one GND line 14), regardless of the number of nodes of the lamp units 11.

As shown in FIGS. 5 to 5C, the vehicle interior lighting system 1 in the embodiment of the invention has fewer wires than the lighting unit 6 both when performing LIN communication and when performing CAN communication, and this difference in the number of wires becomes more pronounced as the number of nodes of the lamp units increases.

In addition, in the vehicle interior lighting system 1 that performs CAN communication, the effect production instruction signal S₁ is transmitted only once to each of the plural lamp units 11 per effect production instruction, in the same manner as in the vehicle interior lighting system 1 that performs LIN communication. Therefore, the communication volume of the effect production instruction signal S₁ transmitted to produce one effect is constant regardless of the duration of the effect. Therefore, the amount of data in the instruction signal transmitted from the host ECU 10 to the plural lamp units 11 can be suppressed. In the vehicle interior lighting system 1 that performs CAN communication, the effect production instruction signal S₁ is transmitted through two bus cables 12.

In addition, the vehicle interior lighting system 1 that performs CAN communication has the same features as those of the vehicle interior lighting system 1 that performs LIN communication described above, such as the feature of being able to combine only necessary pieces of the instruction information and include the combined pieces of information in the effect production instruction signal S₁ each time the effect production instruction signal S₁ is transmitted, and the feature of being able to synchronize the timings at which the control ICs 111 of the plural lamp units 11 change the outputs of the light-emitting elements 112 of the plural lamp units 11.

### Effects of the Embodiment

The vehicle interior lighting system 1 in the embodiment of the invention is a system which performs LIN communication and in which the plural lamp units 11 are connected by one bus cable 12, or a system which performs CAN communication and in which the plural lamp units 11 are connected by two bus cables 12 and, in both cases, the operation of the plural lamp units 11 can be controlled by the effect production instruction signal that is transmitted only once from the host ECU 10 to each of the plural lamp units 11 to produce one effect.

That is, according to the embodiment of the invention, it is possible to provide a vehicle interior lighting system in which the number of wires connecting plural lamp units to a host ECU that controls the plural lamp units is small and which can also suppress an amount of data in an instruction signal transmitted from the host ECU to the plural lamp units.

Although the embodiment of the invention has been described, the invention is not intended to be limited to the embodiment, and the various kinds of modifications can be implemented without departing from the gist of the invention. In addition, the constituent elements in the embodiment can be arbitrarily combined without departing from the gist of the invention. In addition, the embodiment described above does not limit the invention according to the claims. Further, please note that not all combinations of the features described in the embodiment are necessary to solve the problem of the invention.

### REFERENCE SIGNS LIST

1 VEHICLE INTERIOR LIGHTING SYSTEM
10 HOST ECU
11 LAMP UNIT
111 CONTROL IC
112 LIGHT-EMITTING ELEMENT
12 BUS CABLE

1. A vehicle interior lighting system that performs LIN communication or CAN communication, the vehicle interior lighting system comprising:
a plurality of lamp units connected by one or two bus cables; and
a host ECU that transmits an effect production instruction signal to the plurality of lamp units through the bus cable or cables, the effect production instruction signal instructing a content of an effect produced by a light emission operation of the plurality of lamp units,
wherein each of the plurality of lamp units comprises a light-emitting element and a control IC that controls output of the light-emitting element according to the content of the effect production instruction signal, and
wherein the effect production instruction signal is transmitted once to each of the plurality of lamp units per effect production instruction, regardless of duration of effect.

2. The vehicle interior lighting system according to claim 1, wherein each time transmitting the effect production instruction signal, the host ECU combines only necessary pieces among a plurality of pieces of instruction information and includes the combination in the effect production instruction signal.

3. The vehicle interior lighting system according to claim 1, wherein when instruction information that specifies an operation of simultaneously changing outputs of the plurality of lamp units is included in the effect production instruction signal, timings at which the control ICs of the plurality of lamp units change outputs of the light-emitting elements are synchronized.

4. The vehicle interior lighting system according to claim 1, wherein each of the plurality of lamp units comprises a plurality of the light-emitting elements.

5. The vehicle interior lighting system according to claim 1, wherein the vehicle interior lighting system performs LIN communication, and wherein the number of nodes of the plurality of lamp units is not less than 15.
